(19) United States
(12) Patent Application Publication
(10) Pub. No.: US 2010/0191830 A1
(43) Pub. Date: Jul. 29, 2010

(54) METHOD AND APPARATUS FOR PROVIDING COMMUNITY WIDGET

(75) Inventors: Bong-yen KIM, Seongnam-si (KR); Soo-kang BAE, Seongnam-si (KR); Seung-han GO, Yongin-si (KR); Jun-young OH, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/550,450

(22) Filed: Aug. 31, 2009

(30) Foreign Application Priority Data
Jan. 23, 2009 (KR) 10-2009-0006020

(51) Int. Cl. G06F 21/00; G06F 15/16

(52) U.S. Cl. 709/219; 726/3

(57) ABSTRACT

Provided are a method and apparatus for providing a community widget at a first client device, the method including: receiving a client widget including authentication information from a server; searching a second client device in which the client widget is installed; performing mutual authentication with the second client device by using the authentication information; and transmitting, if the mutual authentication is successful, a community widget to the second client device.

### CROSS-REFERENCE TO RELATED PATENT APPLICATION

This application claims priority from Korean Patent Application No. 10-2009-0006020, filed on Jan. 23, 2009, in the Korean Intellectual Property Office, the disclosure of which is incorporated herein in its entirety by reference.

### BACKGROUND OF THE INVENTION

1. Field of the Invention

The present general inventive concept relates to a widget, and more particularly, to a method and apparatus for providing a community widget.

2. Description of the Related Art

A widget refers to a personalized small program used in computing systems such as a personal computer, a mobile device, a digital TV, or the like, which enables easy access to frequently used functions or delivers certain visual information. Recently, the widget is being considered further because it can be easily developed. Although there are differences according to circumstances, a simple widget can be written by using some image files, extensible markup language (XML) or hyper text markup language (html) of several hundred lines, Java scripts, or Visual Basic (VB) script codes. A contents provider operates a widget server in which various widgets are stored and a user downloads a desired widget application from the widget server via a web site to a device of the user. Also, a widget installed in the device in the form of a native code is available. The widget application is operated by a widget engine.

A social network service (SNS) is a personal networking information managing service through which communication with other people is possible and contents can be shared. Examples of the SNS are Cyworld in Korea, MySpace in the U.S.A., and Mixi in Japan. The user connects to a server and goes through an authentication procedure in order to join a desired community, and has to download necessary software from a server and install the software in a client device.

### SUMMARY OF THE INVENTION

The present general inventive concept provides a method and apparatus for providing a community widget through which communication between users is possible and which can be transmitted or received between the users, and through which the users can conveniently join or withdraw from a community.

According to an aspect of the present general inventive concept, there is provided a method of providing a community widget in a first client device, the method including: receiving a client widget including authentication information from a server; searching for a second client device in which the client widget is installed; performing mutual authentication with the second client device by using the authentication information; and transmitting, if the mutual authentication is successful, a community widget to the second client device.

The method may further include generating the community widget according to a request of a user and registering the community widget at the server.

The authentication information may be in an extensible markup language (XML) format. The authentication information may include identification (ID), a password, and a certificate.

According to another aspect of the present general inventive concept, there is provided a method of providing a community widget in a second client device, the method including: receiving a client widget including authentication information from a server; performing, if mutual authentication is requested by a first client device, mutual authentication by using the authentication information; receiving, if the mutual authentication is successful, a community widget from the first client device; and transmitting to the server a request for joining a community corresponding to the community widget by using the authentication information.

The method may further include: when a user requests deleting the community widget, transmitting a request to withdraw from the community to the server by using the authentication information; and deleting the community widget from the second client device.

According to another aspect of the present general inventive concept, there is provided a community widget providing apparatus including: a web browser for receiving from a server a client widget including authentication information and installing the client widget; and a widget engine for driving a widget, wherein the client widget searches for a second client device in which the client widget is installed, and performs mutual authentication with the second client device by using the authentication information, and if the mutual authentication is successful, transmits a community widget to the second client device.

According to another aspect of the present general inventive concept, there is provided a community widget providing apparatus including: a web browser for receiving from a server a client widget including authentication information and installing the client widget; and a widget engine for driving a widget, wherein when mutual authentication is requested by a first client device, the client widget performs mutual authentication by using the authentication information, and if the mutual authentication is successful, the client widget receives from the first client device a community widget and installs the community widget, and the community widget extracts the authentication information from the client widget, and transmits a request for joining a community corresponding to the community widget by using the extracted authentication information to the server.

### BRIEF DESCRIPTION OF THE DRAWINGS

The above and other aspects of the present general inventive concept will become more apparent by describing in detail exemplary embodiments thereof with reference to the attached drawings, in which:

FIG. 1 is a diagram illustrating apparatuses for providing a community widget and a server, according to an exemplary embodiment;

FIG. 2 is a flowchart illustrating a method of providing a community widget according to another exemplary embodiment;

FIG. 3 is a flowchart illustrating a method of providing a community widget according to another exemplary embodiment; and

FIG. 4 illustrates interactions between community widget providing apparatuses and a server, according to another exemplary embodiment.

### DETAILED DESCRIPTION OF EXEMPLARY EMBODIMENTS

Exemplary embodiments will now be described more fully with reference to the accompanying drawings, in which exemplary embodiments of the present general inventive concept are shown.

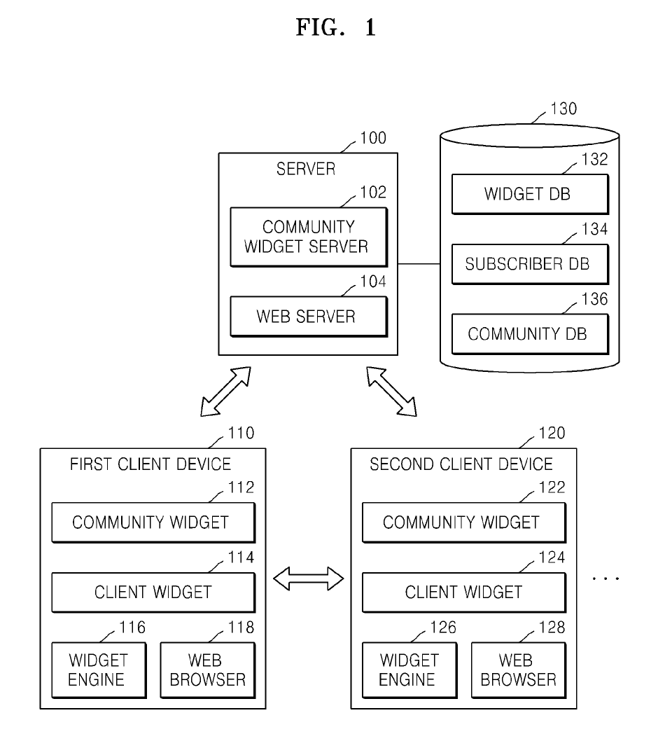

FIG. 1 a diagram illustrating apparatuses for providing a community widget and a server 100, according to an exemplary embodiment.

Referring to FIG. 1, the server 100 includes a web server 104 that processes a service subscription of a user, provides a download service of a client widget and a widget creation tool, and processes community joining of a user, and a community widget server 102 that supports activities of the users in the community using a community widget. Also, the user may upload the community widget created by the user via the web server 104 or download a community widget provided by another user or another service provider. The server 100 includes a storage unit or a database 130. In the storage unit or data base (DB) 130, a widget DB 132 for storing a client widget and a community widget, a subscriber DB 134 for storing information on service subscribers, and a community DB 136 for storing information about joiners of each community may be included. Also, the server 100 may further include a widget creation tool (not shown) for providing a community widget creation service through which the user can easily create a community widget by connecting to the server 100.

First and second client devices 110 and 120, which are community widget providing apparatuses, respectively include widget engines 116 and 126. The first and second client devices 110 and 120 also respectively include web browsers 118 and 128 for transmitting subscription requests of users, to the server 100, and receiving client widgets including authentication information from the server 100 to install the client widgets. Authentication information is for authentication of the server 100 or other client devices, may include identification (ID), a password and a certificate, and may be in an extensible markup language (XML) format. The ID and the password are coded and stored in a client widget. Also, the first and second client devices 110 and 120 may further respectively include a widget creation tool (not shown) for creating a community widget according to requests of the users.

The first client device 110 creates a community widget 112 using the widget creation tool or receives a community widget 112 created by another person from another device (not shown) and installs the community widget 112. When the community widget 112 is created according to a request of a user, the community widget 112 is registered at the server 100 or is uploaded via the web browser 118. When the community widget 112 is registered, the server 100 processes creation of a new community by storing information about the community. Upon a request of a user for searching for a friend, the client widget 114 of the first client device 110 searches for other client devices in which an identical client widget is installed. When the user selects the second client device 120 from among the detected devices, mutual authentication with a client widget 124 of the second client device 120, which is identical to the client widget 114 of the first client device 110, is performed using the authentication information included in the client widget 114. When the mutual authentication is successful, the client widget 114 transmits the community widget 112 to the second client device 120.

The client widget 124 of the second client device 120, when receiving a request for mutual authentication from the client widget 114 of the first client device 110, performs mutual authentication using authentication information included in the client widget 124 of the second client device 120. When the mutual authentication is successful, the client widget 124 receives a community widget 112 from the first client device 110 and installs the same in the second client device 120, which is the community widget 122. The installed community widget 122 extracts authentication information from the client widget 124 and transmits a request for joining a community corresponding to the community widget 122, to the server 100 using the extracted authentication information. A process of joining a community may be conducted before the client widget 124 downloads the community widget 122 or while the client widget 124 is downloading the community widget 122. Accordingly, just by agreeing to download the community widget 122, the user of the second client device 120 can automatically join a community corresponding to the communication widget 122 by connecting to the server 100 without having to go through a joining procedure.

Also, when the user of the second client device 120 requests deleting the community widget 122, the user does not have to connect to the server 100 and go through a withdrawal procedure from the community because the client widget 124 or the community widget 122 transmits a community withdrawal request to the server 100 using the authentication information included in the client widget 124 when deleting the community widget 122 is triggered, and thus, a withdrawal procedure is automatically performed. When there is a request for searching for a friend by the user of a user of the second client device 120, the client widget 124 searches for a third client device (not shown) in which a client widget identical to the client widget 124 is installed, and performs mutual authentication with the third client device by using authentication information of the client widget 124. When the mutual authentication is successful, the client widget 124 transmits the community widget 122 to the third client device. A user of the third client device also automatically joins a corresponding community just by agreeing to receive the community widget 122.

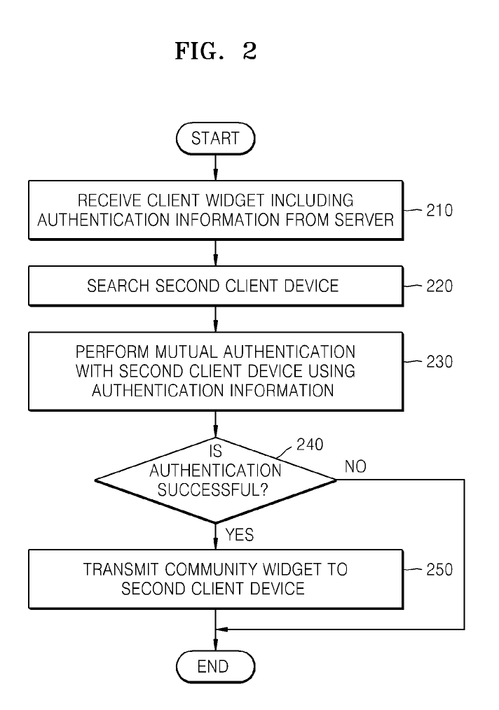

FIG. 2 is a flowchart illustrating a method of providing a community widget according to another exemplary embodiment of the present invention.

Referring to FIG. 2, in operation 210, the first client device 110 receives from the server 100 the client widget 114 including authentication information of the first client device 110, and installs the client widget 114 therein. Next, in operation 220, the second client device 120 that the first client device wants to admit to a community, is searched for. In operation 230, when the search is successful, mutual authentication with the detected second client device 120 is performed using the authentication information included in the client widget 114. If the mutual authentication is successful in operation 240, the community widget 112 for performing a community activity is transmitted to the second client device 120 in operation 250.

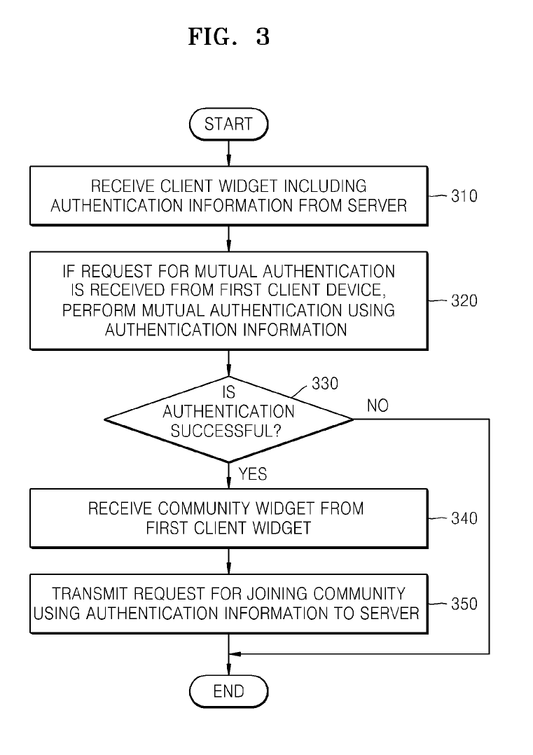

FIG. 3 is a flowchart illustrating a method of providing a community widget according to another exemplary embodiment of the present general inventive concept.

Referring to FIG. 3, in operation 310, the second client device 120 receives the client widget 124 including authentication information from the server 100 and installs the client widget 124 therein. In operation 320, if mutual authentication is requested by the first client device 110, the second client device 120 performs mutual authentication using the authentication information of the second client device 120, which is included in the client widget 124. If it is determined that the mutual authentication is successful in operation 330, in operation 340, the community widget 122 is received from the first client device 110 to be installed. Also, in operation 350, the second client device 120 transmits a request for joining a community corresponding to the community widget 122 to the server 100 using the authentication information of the second client device 120.

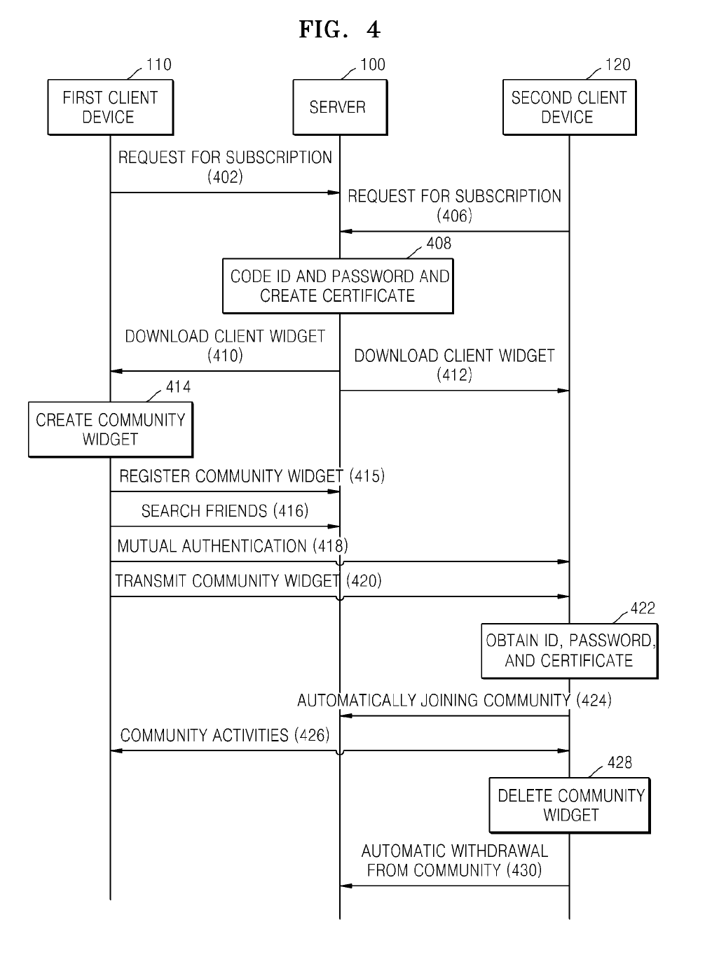

FIG. 4 illustrates interactions between the community widget providing apparatuses and the server 100, according to another exemplary embodiment of the present invention.

In operation 402, when the user of the first client device 110, that is, a first user, inputs an ID and a password to a website for subscription to a service and for downloading a client widget, the first client device 110 transmits a subscription request, to a server 100. In operation 408, the server 100 encodes the ID and the password of the first user and creates a certificate that is needed when the first user communicates with the community widget 112 or the client widget 124 of another user later. In operation 410, the encoded ID and password and the certificate are stored in the client widget 114 and transmitted to the first client device 110 with the client widget 114. In the same manner, the second client device 120 transmits a subscription request to the server 100 when an input from the user of the second client device 120, a second user, is received in operation 406, and downloads the client widget 124 in operation 412, and authentication information, that is, an encoded ID and password and a certificate of the second client device 120, are stored in the received client widget 124. The authentication information may be defined in various formats. For example, the ID and the password of a user may be defined in an XML format.

The first user creates the community widget 112 having a function desired by the first user by using a widget creation tool in operation 414. The first user may connect to the server 100 and create a community widget by using an automated widget development kit (WDK) provided by the server 100, or may immediately create a community widget by using a software development kit (SDK). In operation 415, the first client device 110 registers the created community widget 112 at the server 100. Consequently, a new community is created. The server 100 stores information about the registered community widget 112 and conducts community management such as joining or withdrawal processes of a corresponding community based on the information. The first user may upload the community widget 112, which is created by the first user, in the server 100 and provide the same to other users.

In operation 416, the first client device 110 searches for friends in order to allow a user who the first user wants to join in the created community. A friend search is a process of selecting a user who is wanted from among service subscribers who have installed a client widget, and the user may be searched for from a user list that is already registered at the first client device 110 or from a user list provided by the server 100. However, the method of searching for friends is not limited thereto, and users who want to be a member of the community may also be searched for via other wired or wireless networks. In operation 418, when the second user who is to join the community is selected, a request for mutual authentication is transmitted to the second client device 120 that is being used by the second user, to perform mutual authentication. Mutual authentication is performed via the certificate included in the client widgets 114 and 124 installed in the first and second client devices 110 and 120, respectively. When the mutual authentication is successful and the second user agrees to join the community, the first client device 110 transmits the community widget 112 to the second client device 120 by using a transmission protocol such as WiFi, in operation 420. Various transmission protocols based on wired or wireless networks may be used in transmitting the community widget 112.

In operation 420, the second client device 120 receives the community widget 122 from the first client device 110. When the community widget is stored in the server 100, the community widget may be downloaded from the server 100. The joining of the community is automatically processed together with installation of the community widget 122. That is, in operation 422, authentication information of the second user is obtained from the client widget 124 installed in the second client device 120, and in operation 424, the authentication information is used to perform mutual authentication with the server 100 and joining the community, thereby completing the installation of the community widget 122. Here, additional information needed for community activities may be input by the first and second users and registered at the server 100. Accordingly, the community activities of the first user and the second user are made possible in operation 426. For example, the second user using the community widget 122 may share contents of the second user with other community joiners via the server 100 or may transmit the contents only to a specific joiner through the community widget 122. If the second user wants to withdraw from the community, the second user simply has to command deletion of the community widget 122. That is, the second client device 120 deletes the community widget 122 and transmits to the server 100 a request to withdraw from the community by the second user to automatically process the withdrawal.

As described above, a user can join or withdraw from a community just by installing or deleting a community widget. Thus, the community widget may be interpreted like an avatar which represents the user him/herself, and the user can communicate with others via the community widget and share contents with each other, thereby creating a social network in a convenient and interesting manner.

While the present general inventive concept has been particularly shown and described with reference to exemplary embodiments thereof and drawings, the exemplary embodiments should be considered in a descriptive sense only and not for purposes of limitation. Therefore, the scope of the present general inventive concept is defined not by the detailed description of the present general inventive concept but by the appended claims, and it should be understood that exemplary embodiments are to cover all modifications and equivalents falling within the scope of the present general inventive concept. The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

What is claimed is:

1. A method of providing a community widget in a first client device, the method comprising:
receiving a client widget including authentication information;
searching for a second client device in which the client widget is installed;
performing mutual authentication with the second client device by using the authentication information; and
transmitting, if the mutual authentication is successful, the community widget to the second client device.

2. The method of claim 1, further comprising generating the community widget according to a request of a user of the first client device and registering the community widget at the server.

3. The method of claim 1, wherein the authentication information is in an extensible markup language (XML) format.

4. The method of claim 1, wherein the authentication information comprises identification, a password, and a certificate.

5. The method of claim 1, wherein the community widget is an application through which the first and second client devices communicate with each other and share respective contents stored therein.

6. The method of claim 1, further comprising transmitting a request for subscription to the server from the first client device to the server before the receiving the client widget from the server, if the client widget is received from the server.

7. A computer readable recording medium having embodied thereon a computer program for executing a method of providing a community widget in a first client device, the method comprising:
receiving a client widget including authentication information from a server;
searching for a second client device in which the client widget is installed;
performing mutual authentication with the second client device by using the authentication information; and
transmitting, if the mutual authentication is successful, the community widget to the second client device.

8. A method of providing a community widget in a first client device, the method comprising:
receiving a client widget including authentication information from a server;
performing, if mutual authentication is requested by a second client device, mutual authentication by using the authentication information;
receiving, if the mutual authentication is successful, the community widget from the second client device; and
transmitting to the server a request for joining a community corresponding to the community widget by using the authentication information.

9. The method of claim 8, further comprising:
if the user of the first client device requests deleting the community widget, controlling the client widget or the communication widget to transmit a request to withdraw the user of the first client device from the community to the server by using the authentication information; and
deleting the community widget from the first client device.

10. The method of claim 8, wherein a user of the first client device is joined in the community if the community widget is received by the user at the first client device.

11. A computer readable recording medium having embodied thereon a computer program for executing a method of providing a community widget in a first client device, the method comprising:
receiving a client widget including authentication information from a server;
performing, when mutual authentication is requested by a second client device, mutual authentication by using the authentication information;
receiving, if the mutual authentication is successful, the community widget from the second client device; and
transmitting to the server a request for joining a community corresponding to the community widget by using the authentication information.

12. A community widget providing apparatus comprising:
a web browser that receives from a server a client widget including authentication information and installs the client widget; and
a widget engine that drives the client widget,
wherein the client widget searches for a second client device in which the client widget is installed, and performs mutual authentication with the second client device by using the authentication information, and if the mutual authentication is successful, transmits a community widget to the second client device.

13. The community widget providing apparatus of claim 12, wherein the web browser registers at the server the community widget created according to a request of a user of the community widget providing apparatus.

14. The community widget providing apparatus of claim 12, wherein the authentication information is in an extensible markup language (XML) format.

15. The community widget providing apparatus of claim 12, wherein the authentication information comprises identification, a password, and a certificate.

16. A community widget providing apparatus comprising:
a web browser that receives from a server a client widget including authentication information and installs the client widget; and
a widget engine that drives the client widget,
wherein when mutual authentication is requested by a second client device, the client widget performs mutual authentication by using the authentication information, and if the mutual authentication is successful, the client widget receives from the second client device a community widget and installs the community widget, and
wherein the community widget extracts the authentication information from the client widget, and transmits a request for joining a community corresponding to the community widget by using the extracted authentication information to the server.

17. The community widget providing apparatus of claim 16, wherein when a user of the community widget providing apparatus requests to delete the community widget, the client widget or the community widget transmits to the server a request to withdraw the user from the community using the authentication information, whereby the community widget is deleted from the community widget providing apparatus.
